(19) United States
(12) Patent Application Publication
(10) Pub. No.: US 2025/0165825 A1
(43) Pub. Date: May 22, 2025

(54) SYSTEMS AND METHODS FOR TENSOR-BASED VARIATIONAL QUANTUM ALGORITHM COST FUNCTION LANDSCAPE GENERATION

(71) Applicant: JPMORGAN CHASE BANK, N.A., New York, NY (US)

(72) Inventors: Zichang HE, Jersey City, NJ (US); Ruslan SHAYDULIN, New York, NY (US); Marco PISTOIA, Jersey City, NY (US)

(21) Appl. No.: 18/516,460

(22) Filed: Nov. 21, 2023

(51) Int. Cl. G06N 10/20; G06N 10/70

(52) U.S. Cl. CPC G06N 10/20; G06N 10/70

(57) ABSTRACT

In some aspects, the techniques described herein relate to a method including: receiving a cost function, where the cost function is a function of parameters of a quantum circuit; discretizing the cost function to determine a number of dimensions and a number of elements in each dimension; formulating a landscape tensor, wherein the landscape tensor is formulated based on, and includes, the number of dimensions and the number of elements in each dimension; randomly sampling values of the parameters of the quantum circuit; executing the quantum circuit with the values of the parameters, wherein executing the quantum circuit generates values of the cost function; inserting the values of the cost function as values of corresponding elements in the number of elements included in the landscape tensor; and solving a low-rank tensor completion problem to estimate the values of empty elements in the landscape tensor.

### BACKGROUND

### 1. Field of the Invention

Aspects generally relate to systems and methods for tensor-based VQA cost function landscape generation

### 2. Description of the Related Art

Variational quantum algorithms (VQAs) are a broad class of algorithms that have the potential of quantum advantage in many different industries. A particular challenge associated with VQAs is understanding the properties of associated cost functions. Learning (i.e., reconstructing) the landscape of a VQA cost function is important in developing and testing new variational quantum algorithms. Reconstructing the landscape of a VQA, however, conventionally requires a large number of sample simulations or a large amount of quantum resource. Thus, the problem (i.e., the “curse”) of dimensionality arises when attempting to reconstruct the landscape of VQA cost functions where an associated quantum circuit includes a large number of parameters.

### SUMMARY

In some aspects, the techniques described herein relate to a method including: receiving, at a classical computing device, a cost function, where the cost function is a function of parameters of a quantum circuit; discretizing the cost function to determine a number of dimensions and a number of elements in each dimension; formulating a landscape tensor, wherein the landscape tensor is formulated based on, and includes, the number of dimensions and the number of elements in each dimension; randomly sampling values of the parameters of the quantum circuit; executing the quantum circuit with the values of the parameters, wherein executing the quantum circuit generates values of the cost function; inserting the values of the cost function as values of corresponding elements in the number of elements included in the landscape tensor; and solving a low-rank tensor completion problem to estimate the values of empty elements in the number of elements included in the landscape tensor.

In some aspects, the techniques described herein relate to a method, including: storing the landscape tensor in a factorized form.

In some aspects, the techniques described herein relate to a method, wherein the factorized form includes only low-rank decomposed factors of the landscape tensor.

In some aspects, the techniques described herein relate to a method, including: constructing a training data set from the values of the parameters of the quantum circuit.

In some aspects, the techniques described herein relate to a method, wherein the low-rank tensor completion problem minimizes an approximation error of the training data by solving low-rank factors.

In some aspects, the techniques described herein relate to a method, wherein the low-rank factors include.

In some aspects, the techniques described herein relate to a method, wherein each element of the landscape tensor is represented by a vector of matrices.

In some aspects, the techniques described herein relate to a system including at least one classical computing device including a processor and a memory, and at least one quantum computing device including a quantum processor, wherein the at least one classical computing device and the at least one quantum computing device are configured for operative communication with each other, and wherein the system is configured to: receive, at the at least one classical computing device, a cost function, where the cost function is a function of parameters of a quantum circuit; discretize the cost function to determine a number of dimensions and a number of elements in each dimension; formulate a landscape tensor, wherein the landscape tensor is formulated based on, and includes, the number of dimensions and the number of elements in each dimension; randomly sample values of the parameters of the quantum circuit; execute the quantum circuit with the values of the parameters, wherein executing the quantum circuit generates values of the cost function; insert the values of the cost function as values of corresponding elements in the number of elements included in the landscape tensor; and solve a low-rank tensor completion problem to estimate the values of empty elements in the number of elements included in the landscape tensor.

In some aspects, the techniques described herein relate to a system, wherein the system is configured to: store the landscape tensor in a factorized form.

In some aspects, the techniques described herein relate to a system, wherein the factorized form includes only low-rank decomposed factors of the landscape tensor.

In some aspects, the techniques described herein relate to a system, wherein the system is configured to: construct a training data set from the values of the parameters of the quantum circuit.

In some aspects, the techniques described herein relate to a system, wherein the low-rank tensor completion problem minimizes an approximation error of the training data by solving low-rank factors.

In some aspects, the techniques described herein relate to a system, wherein the low-rank factors include.

In some aspects, the techniques described herein relate to a system, wherein each element of the landscape tensor is represented by a vector of matrices.

In some aspects, the techniques described herein relate to a non-transitory computer readable storage medium, including instructions stored thereon, which instructions, when read and executed by one of a classical computer processor or a quantum computer processor, cause the classical computer processor or the quantum computer processor to perform steps including: receiving, at a classical computing device, a cost function, where the cost function is a function of parameters of a quantum circuit; discretizing the cost function to determine a number of dimensions and a number of elements in each dimension; formulating a landscape tensor, wherein the landscape tensor is formulated based on, and includes, the number of dimensions and the number of elements in each dimension; randomly sampling values of the parameters of the quantum circuit; executing the quantum circuit with the values of the parameters, wherein executing the quantum circuit generates values of the cost function; inserting the values of the cost function as values of corresponding elements in the number of elements included in the landscape tensor; and solving a low-rank tensor completion problem to estimate the values of empty elements in the number of elements included in the landscape tensor.

In some aspects, the techniques described herein relate to a non-transitory computer readable storage medium, including: storing the landscape tensor in a factorized form.

In some aspects, the techniques described herein relate to a non-transitory computer readable storage medium, wherein the factorized form includes only low-rank decomposed factors of the landscape tensor.

In some aspects, the techniques described herein relate to a non-transitory computer readable storage medium, including: constructing a training data set from the values of the parameters of the quantum circuit.

In some aspects, the techniques described herein relate to a non-transitory computer readable storage medium, wherein the low-rank tensor completion problem minimizes an approximation error of the training data by solving low-rank factors including.

In some aspects, the techniques described herein relate to a non-transitory computer readable storage medium, wherein each element of the landscape tensor is represented by a vector of matrices.

### BRIEF DESCRIPTION OF THE DRAWINGS

FIG. 1 is a depiction of a variational quantum algorithm circuit and a visualization of a landscape of a cost function, in accordance with aspects.

FIG. 2 is a logical flow of a tensor-based VQA cost function landscape generation process, in accordance with aspects.

FIG. 3 is a block diagram of a system for tensor-based VQA cost function landscape generation, in accordance with aspects.

FIG. 4 is a block diagram of a technology infrastructure and computing device for implementing certain aspects of the present disclosure, in accordance with aspects.

### DETAILED DESCRIPTION

Aspects generally relate to systems and methods for tensor-based VQA cost function landscape generation.

A parameterized quantum circuit may be thought of in terms of a machine learning model. Like traditional machine learning models, a parameterized quantum circuit includes parameters that may be optimized in order to minimize loss. Similar to classical machine learning models, a cost function may be used to measure “loss” of the quantum circuit. Loss, in machine learning terms, is a measure of how optimal a machine learning model's performance is. A cost function is also commonly referred to as a loss function. A lower loss value of a cost function indicates a higher accuracy of predictions of a corresponding model.

Variational quantum algorithms (VQAs), use classical computer systems and optimization methods to optimize the parameters of a quantum circuit. In a VQA, a quantum circuit may form a subroutine of the VQA, but the VQA may include other subroutines that are executed on a classical computer. For instance, a VQA may construct and compute a cost function for a corresponding quantum circuit on a classical computer. The cost function of a VQA is formulated to measure some objective (e.g., to measure loss of the quantum circuit) based on output (e.g., a measurement) from the quantum circuit. Output from the quantum circuit may be estimated using the constructed cost function.

In a VQA, an architecture of a quantum circuit may remain fixed with respect to a corresponding cost function, but parameter values of the quantum circuit (e.g., quantum gate parameters) may be variable. Another subroutine of a VQA may include providing optimized parameter values with which to update a corresponding quantum circuit's parameters. A classical optimization routine (e.g., an optimization loop or training loop) of a VQA may generate updated parameter values based on a corresponding cost function and output from a quantum circuit. A quantum circuit's parameters may be tuned using the updated parameter values and may configure the quantum circuit to generate more accurate output. These subroutines of a VQA may repeat until output from the corresponding quantum circuit is optimized. A VQA may also include subroutines that convert data between classical (i.e., binary) data to quantum data when data is exchanged between the two architectures.

The ability to learn (i.e., reconstruct) the landscape of a VQA cost function is an important step in developing and testing new VQAs. A landscape of a VQA cost function is essentially a dimensional model of the cost function that is generated on a classical computer. A landscape of a VQA cost function may include elements that represent parameters of a corresponding quantum circuit. A cost function may be a function of the parameters of the corresponding quantum circuit. Accordingly, reconstructing a VQA cost function's landscape where the corresponding quantum circuit includes a high number of parameters can be extremely computationally expensive and memory intensive due to the massive number of elements that a reconstruction may include.

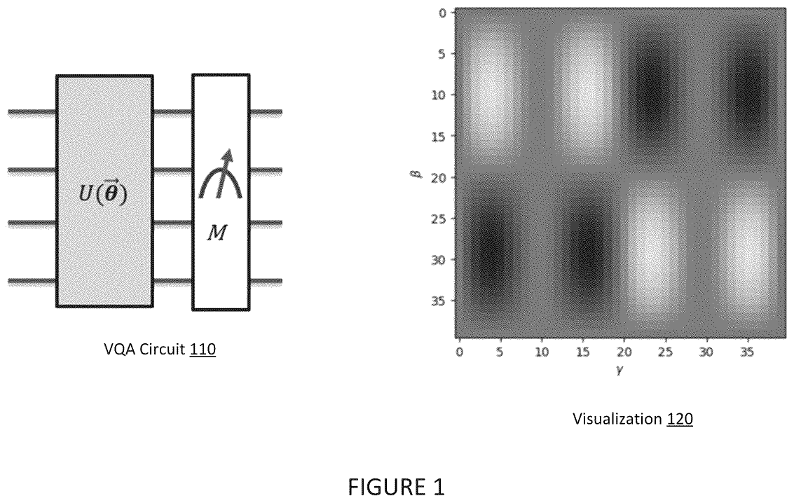

FIG. 1 is a depiction of a variational quantum algorithm circuit and a visualization of a landscape of a cost function of a VQA, in accordance with aspects. FIG. 1 includes VQA circuit 110, which is a depiction of an exemplary VQA circuit, and visualization 120. VQA circuit 110 may include parametrized quantum gates and a measurement of exemplary quantum data. Visualization 120 is a reconstruction of a cost function for the quantum approximate optimization algorithm (QAOA), which is an exemplary VQA. The cost function landscape visualized in visualization 120 includes only two parameters (i.e., p and y). It is relatively inexpensive to reconstruct a visualization of a cost function for a VQA having only two parameters. Given a VQA with d parameters (i.e., if 0 has dimension d), for a grid search to be conducted over each dimension with a resolution of N elements, N^{d} number of samples will be needed in order to complete the landscape of the corresponding cost function.

Accordingly, a common grid search executed by a classical computing device may produce visualization 120 due to the relatively low number of samples required and the simplicity of constructing (i.e., plotting) a 2-parameter (i.e., 2 dimensional) visualization. Such simplicity rapidly disappears, however, when dealing with cost functions for quantum circuits having higher numbers of parameters. For instance, even with as few as 10 parameters (let alone, e.g., 1000 parameters), a visualization such as visualization 120 cannot be plotted and a naïve grid search for sampling of landscape element values becomes prohibitively expensive. Moreover, unlike visualization 120, many landscapes are not periodic, which adds additional complexity.

In accordance with aspects, however, a localized landscape of randomly sampled elements of a VQA cost function may be created and missing elements may be estimated. Aspects may apply a low-rank tensor completion process in a VQA cost function landscape reconstruction in order to form an approximated landscape tensor. The landscape tensor may receive randomly sampled and evaluated elements from a quantum circuit and may populate the landscape tensor with the sampled element values. Then, missing element values in the landscape tensor may be estimated by solving a low-rank tensor completion algorithm.

As part of a VQA, aspects may formulate a cost function landscape as a low-rank tensor representation (referred to herein as a landscape tensor). A quantum computing device may sample random values of parameters of a quantum circuit of the VQA and may return the values to a classical computer. Values returned to a classical computer may serve as the training data set for the low-rank landscape tensor model. The VQA may populate the appropriate elements of the landscape tensor with the received sampled values. An estimated landscape tensor may be represented in a low-rank form in order to avoid exponential growth with respect to memory cost. Values missing from the landscape tensor after receipt of sampled values from the quantum circuit may then be estimated by solving a low-rank tensor completion algorithm associated with the landscape tensor. Such an approach does not rely on the periodicity of the landscape function and can instead focus on localized landscape reconstruction.

In accordance with aspects, a tensor-based VQA cost function landscape generation process may include discretizing a quantum circuit cost function, which is analogous to generating the grid on which a landscape will be plotted. The “grid,” however, may be formulated as a landscape tensor, which may be configured to accommodate high dimensionality. Once the landscape tensor has been generated with the proper dimensionality based on the discretized cost function, random samples of points (i.e., elements) in the landscape tensor may be accumulated. The random samples may simulate partial elements of the landscape tensor. A low-rank tensor completion problem may be solved to estimate missing values of empty (i.e., not randomly sampled) points of the landscape tensor. Estimated values in addition to randomly sampled values may completed (i.e., fill out) the landscape visualization with data points.

In accordance with aspects, a tensor-based VQA cost function landscape generation process, as described herein, is orders of magnitude more efficient than using a naïve grid search for sampling points in a VQA landscape. Additionally, the memory requirement for storing a landscape tensor is reduced from exponentially depending on dimension d to linearly depending on dimension d. Accordingly, local landscape reproduction is supported, and landscape reconstruction can be easily adapted into cases having high noise.

In accordance with aspects, a classical computer program that is part of a VQA may be configured to receive a VQA cost function (i.e., ƒ(θ), θ∈R^{d}) as input to a low-rank tensor-based VQA cost function landscape generation process. Output from the tensor-based VQA cost function landscape generation process may be an estimated, or reconstructed, cost function \hat{ƒ}(θ). The reconstructed (i.e., estimated) output cost function \hat{ƒ}(θ) may approximate the input cost function ƒ(θ). In terms of notation used herein, a bolded theta symbol (i.e., θ) represents a vector, while a non-bolded theta symbol (i.e., θ) represents a scalar.

In exemplary aspects, θ may be high dimensional. The classical computer may be configured to discretize the cost function ƒ(θ) and formulate a landscape tensor based on the discretization. In discretizing the cost function, a classical computer may be configured to determine an interested region of θ and a number of grid points (elements) for each dimension therein (i.e., N₁, N₂, N₃, . . . , N_{d}). A classical computer may then be configured to formulate a corresponding landscape tensor \hat{ƒ}(θ) that is a reconstruction of the input cost function ƒ(θ), where the reconstructed cost function \hat{ƒ}(θ) is equal to \hat{ƒ}(θ₁, θ₂, θ₃, . . . , θ_{d})∈R^{N}^{₁}^{×N}^{₂}^{×N}^{₃}^{× . . . N}^{_{d}}.

In accordance with aspects, the size of the generated landscape tensor may be very large. Accordingly, aspects may not be configured to store the landscape tensor. Rather, aspects may be configured to store only the low-rank decomposed factors of the generated landscape tensor. Each element of \hat{ƒ}(θ) may be represented by a vector of matrices. The low-rank decomposed factors of the tensor may be written as {Aᵢ}ᵢ₌₁^{d}, where Aᵢ∈R^{r}^{ᵢ₋₁}^{×n}^{ᵢ}^{×r}^{ᵢ}, where \hat{ƒ}(n₁, n₂, n₃, . . . , n_{d})=G₁(n₁)G₂(n₂)G₃(n₃) . . . G_{d}(n_{d}), and where Gᵢ(nᵢ)=A[:, nᵢ, :] is a R^{r}^{ᵢ₋₁}^{×r}^{ᵢ} matrix. This formulation may be referred to as the tensor-train decomposition form. Accordingly, aspects may not be configured to store \hat{ƒ}(θ) as a full tensor but, rather, may store a factorized version of \hat{ƒ}(θ), which is comparatively much smaller. Thus, the memory cost for storing \hat{ƒ}(θ) is reduced from O(N^{d}) to O(dNr).

In accordance with aspects, a quantum computing device may randomly sample and evaluate partial elements of the cost function. A quantum computing device may randomly select K number of initial samples, where K may be less than 0.01*N^{d} (i.e., less than 1% of the total number of elements) for a good approximation accuracy. The quantum computing device may evaluate these samples and construct a training data set {θⁱ, ƒ(θⁱ)}ᵢ₌₁^{K}. The training data set maybe passed to the classical computing device as input data to reconstruct the landscape tensor.

In accordance with aspects, sampled values (i.e., the training data set) received from the quantum computing device may be received at the classical computing device and inserted into the landscape reconstruction algorithm as a value of an appropriate (i.e., a corresponding) element. The classical computing device may then solve the low-rank tensor completion problem to estimate the values of the landscape tensor elements that were not randomly sampled and evaluated by the quantum computing device. The low-rank tensor completion problem formulation minimizes the approximation error of the training data by solving the low-rank factors {Aᵢ}ᵢ₌₁^{d}:

$${min}_{{\{ {A}_{i} \}}_{i = 1}^{d}} {\sum }_{i = 1}^{K} {( f ( {θ}^{i} ) - \hat{f} ( {θ}^{i} ) )}^{2} .$$

This includes predefining the ranks of {Aᵢ}ᵢ₌₁^{d}, R₁, R₂, . . . , R_{d}, which are positive integers. Then, the process may initialize the factors {Aᵢ}ᵢ₌₁^{d}. The process may alternatively update each Aᵢ, solving the linear systems via the least squares method to minimize the approximation error for the training data.

The process described herein may be iterated until the parameters of an associated quantum circuit are optimized.

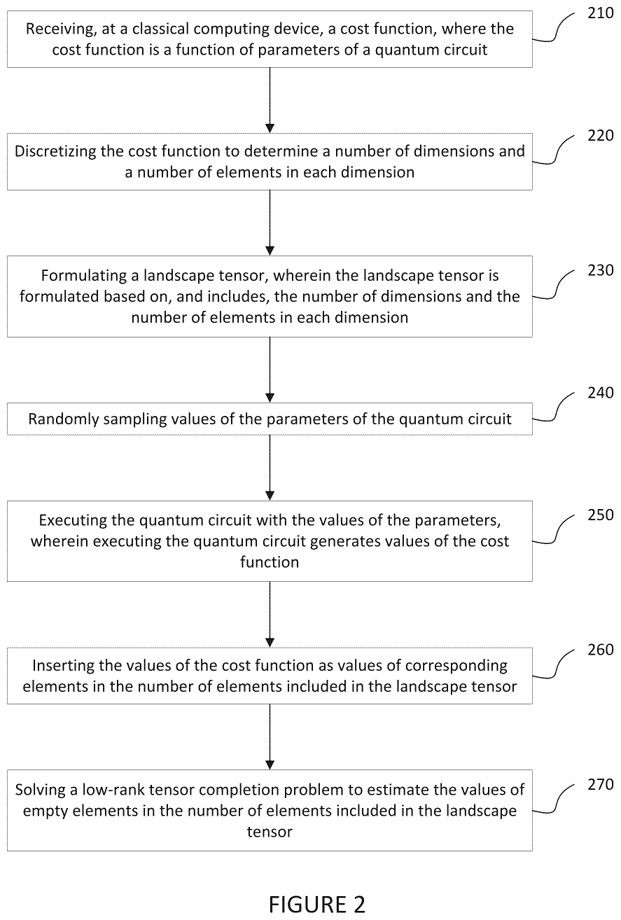

FIG. 2 is a logical flow of a tensor-based VQA cost function landscape generation process, in accordance with aspects.

Step 210 includes receiving, at a classical computing device, a cost function, where the cost function is a function of parameters of a quantum circuit.

Step 220 includes discretizing the cost function to determine a number of dimensions and a number of elements in each dimension.

Step 230 includes formulating a landscape tensor, wherein the landscape tensor is formulated based on, and includes, the number of dimensions and the number of elements in each dimension.

Step 240 includes randomly sampling values of parameters of the quantum circuit.

Step 250 includes executing the quantum circuit with the values of the parameters, wherein executing the quantum circuit generates values of the cost function.

Step 260 includes inserting the values of the cost function as values of corresponding elements in the number of elements included in the landscape tensor.

Step 270 includes solving a low-rank tensor completion problem to estimate the values of empty elements in the number of elements included in the landscape tensor.

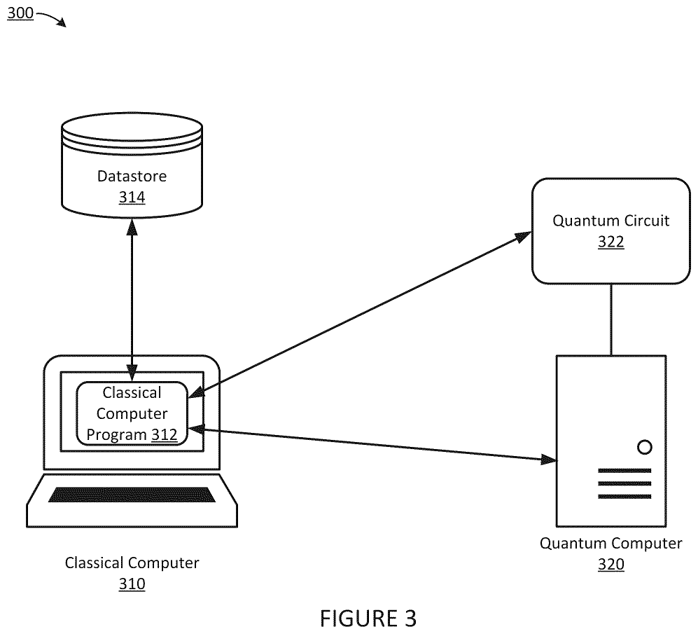

FIG. 3 is a block diagram of a system for tensor-based VQA cost function landscape generation, in accordance with aspects. System 300 includes quantum computer 320, which includes and executes quantum circuit 322. Quantum computer 320 may be a device that performs quantum computations, such as those based on the collective properties of quantum states including superposition, interference, entanglement, etc. As used herein, the terms “quantum computer” and “quantum computing device” are synonymous.

Classical computer 310 may be any suitable general purpose computing device, such as a server, a client device, etc. Classical computer 310 may interface with quantum circuit 322 using classical computer program 312, which may provide input to, and receive output from, quantum computer 320. In one embodiment, classical computer program 312 may generate one or more quantum circuits 322, may transpile the quantum circuit(s) 322 to machine-readable instructions, and may then send the transpiled circuit(s) 322 to quantum computer 320 for execution. Classical computer program 312 may also receive results of the execution of the one or more quantum circuits 322. Classical computer 310 and quantum computer 320 may perform various subroutines of a variational quantum algorithm, as described herein. Quantum circuit 322 and classical computer program 312 may be subroutines of a variational quantum algorithm. Data source 314 may include one or more sources of data. For example, data sources 314 may provide input data to classical computer 310.

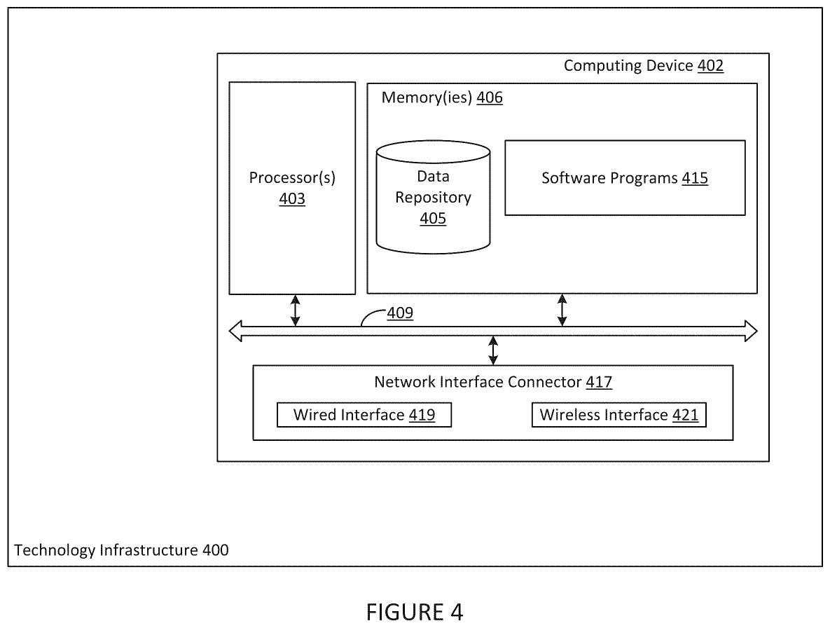

FIG. 4 is a block diagram of a technology infrastructure and computing device for implementing certain aspects of the present disclosure, in accordance with aspects. FIG. 4 includes technology infrastructure 400. Technology infrastructure 400 represents the technology infrastructure of an implementing organization. Technology infrastructure 400 may include hardware such as servers, client devices, and other computers or processing devices. Technology infrastructure 400 may include software (e.g., computer) applications that execute on computers and other processing devices. Technology infrastructure 400 may include computer network mediums, and computer networking hardware and software for providing operative communication between computers, processing devices, software applications, procedures and processes, and logical flows and steps, as described herein.

Exemplary hardware and software that may be implemented in combination where software (such as a computer application) executes on hardware. For instance, technology infrastructure 400 may include webservers, application servers, database servers and database engines, communication servers such as email servers and SMS servers, client devices, etc. The term “service” as used herein may include software that, when executed, receives client service requests and responds to client service requests with data and/or processing procedures. A software service may be a commercially available computer application or may be a custom-developed and/or proprietary computer application. A service may execute on a server. The term “server” may include hardware (e.g., a computer including a processor and a memory) that is configured to execute service software. A server may include an operating system optimized for executing services. A service may be a part of, included with, or tightly integrated with a server operating system. A server may include a network interface connection for interfacing with a computer network to facilitate operative communication between client devices and client software, and/or other servers and services that execute thereon.

Server hardware may be virtually allocated to a server operating system and/or service software through virtualization environments, such that the server operating system or service software shares hardware resources such as one or more processors, memories, system buses, network interfaces, or other physical hardware resources. A server operating system and/or service software may execute in virtualized hardware environments, such as virtualized operating system environments, application containers, or any other suitable method for hardware environment virtualization.

Technology infrastructure 400 may also include client devices. A client device may be a computer or other processing device including a processor and a memory that stores client computer software and is configured to execute client software. Client software is software configured for execution on a client device. Client software may be configured as a client of a service. For example, client software may make requests to one or more services for data and/or processing of data. Client software may receive data from, e.g., a service, and may execute additional processing, computations, or logical steps with the received data. Client software may be configured with a graphical user interface such that a user of a client device may interact with client computer software that executes thereon. An interface of client software may facilitate user interaction, such as data entry, data manipulation, etc., for a user of a client device.

A client device may be a mobile device, such as a smart phone, tablet computer, or laptop computer. A client device may also be a desktop computer, or any electronic device that is capable of storing and executing a computer application (e.g., a mobile application). A client device may include a network interface connector for interfacing with a public or private network and for operative communication with other devices, computers, servers, etc., on a public or private network.

Technology infrastructure 400 includes network routers, switches, and firewalls, which may comprise hardware, software, and/or firmware that facilitates transmission of data across a network medium. Routers, switches, and firewalls may include physical ports for accepting physical network medium (generally, a type of cable or wire—e.g., copper or fiber optic wire/cable) that forms a physical computer network. Routers, switches, and firewalls may also have “wireless” interfaces that facilitate data transmissions via radio waves. A computer network included in technology infrastructure 400 may include both wired and wireless components and interfaces and may interface with servers and other hardware via either wired or wireless communications. A computer network of technology infrastructure 400 may be a private network but may interface with a public network (such as the internet) to facilitate operative communication between computers executing on technology infrastructure 400 and computers executing outside of technology infrastructure 400.

FIG. 4 further depicts exemplary computing device 402. Computing device 402 depicts exemplary hardware that executes the logic that drives the various system components described herein. Servers and client devices may take the form of computing device 402. While shown as internal to technology infrastructure 400, computing device 402 may be external to technology infrastructure 400 and may be in operative communication with a computing device internal to technology infrastructure 400.

In accordance with aspects, system components such as a classical computer, a classical computer program, client devices, servers, various database engines and database services, and other computer applications and logic may include, and/or execute on, components and configurations the same, or similar to, computing device 402.

Computing device 402 includes a processor 403 coupled to a memory 406. Memory 406 may include volatile memory and/or persistent memory. The processor 403 executes computer-executable program code stored in memory 406, such as software programs 415. Software programs 415 may include one or more of the logical steps disclosed herein as a programmatic instruction, which can be executed by processor 403. Memory 406 may also include data repository 405, which may be nonvolatile memory for data persistence. The processor 403 and the memory 406 may be coupled by a bus 409. In some examples, the bus 409 may also be coupled to one or more network interface connectors 417, such as wired network interface 419, and/or wireless network interface 421. Computing device 402 may also have user interface components, such as a screen for displaying graphical user interfaces and receiving input from the user, a mouse, a keyboard and/or other input/output components (not shown).

In accordance with aspects, services, modules, engines, etc., described herein may provide one or more application programming interfaces (APIs) in order to facilitate communication with related/provided computer applications and/or among various public or partner technology infrastructures, data centers, or the like. APIs may publish various methods and expose the methods, e.g., via API gateways. A published API method may be called by an application that is authorized to access the published API method. API methods may take data as one or more parameters or arguments of the called method. In some aspects, API access may be governed by an API gateway associated with a corresponding API. In some aspects, incoming API method calls may be routed to an API gateway and the API gateway may forward the method calls to internal services/modules/engines that publish the API and its associated methods.

A service/module/engine that publishes an API may execute a called API method, perform processing on any data received as parameters of the called method, and send a return communication to the method caller (e.g., via an API gateway). A return communication may also include data based on the called method, the method's data parameters and any performed processing associated with the called method.

API gateways may be public or private gateways. A public API gateway may accept method calls from any source without first authenticating or validating the calling source. A private API gateway may require a source to authenticate or validate itself via an authentication or validation service before access to published API methods is granted. APIs may be exposed via dedicated and private communication channels such as private computer networks or may be exposed via public communication channels such as a public computer network (e.g., the internet). APIs, as discussed herein, may be based on any suitable API architecture. Exemplary API architectures and/or protocols include SOAP (Simple Object Access Protocol), XML-RPC, REST (Representational State Transfer), or the like.

The various processing steps, logical steps, and/or data flows depicted in the figures and described in greater detail herein may be accomplished using some or all of the system components also described herein. In some implementations, the described logical steps or flows may be performed in different sequences and various steps may be omitted. Additional steps may be performed along with some, or all of the steps shown in the depicted logical flow diagrams. Some steps may be performed simultaneously. Some steps may be performed using different system components. Accordingly, the logical flows illustrated in the figures and described in greater detail herein are meant to be exemplary and, as such, should not be viewed as limiting. These logical flows may be implemented in the form of executable instructions stored on a machine-readable storage medium and executed by a processor and/or in the form of statically or dynamically programmed electronic circuitry.

The system of the invention or portions of the system of the invention may be in the form of a “processing device,” a “computing device,” a “computer,” an “electronic device,” a “mobile device,” a “client device,” a “server,” etc. As used herein, these terms (unless otherwise specified) are to be understood to include at least one processor that uses at least one memory. The at least one memory may store a set of instructions. The instructions may be either permanently or temporarily stored in the memory or memories of the processing device. The processor executes the instructions that are stored in the memory or memories in order to process data. A set of instructions may include various instructions that perform a particular step, steps, task, or tasks, such as those steps/tasks described above, including any logical steps or logical flows described above. Such a set of instructions for performing a particular task may be characterized herein as an application, computer application, program, software program, service, or simply as “software.” In one aspect, a processing device may be or include a specialized processor. As used herein (unless otherwise indicated), the terms “module,” and “engine” refer to a computer application that executes on hardware such as a server, a client device, etc. A module or engine may be a service.

As noted above, the processing device executes the instructions that are stored in the memory or memories to process data. This processing of data may be in response to commands by a user or users of the processing device, in response to previous processing, in response to a request by another processing device and/or any other input, for example. The processing device used to implement the invention may utilize a suitable operating system, and instructions may come directly or indirectly from the operating system.

The processing device used to implement the invention may be a general-purpose computer. However, the processing device described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

It is appreciated that in order to practice the method of the invention as described above, it is not necessary that the processors and/or the memories of the processing device be physically located in the same geographical place. That is, each of the processors and the memories used by the processing device may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further aspect of the invention, be performed by a single component. Further, the processing performed by one distinct component as described above may be performed by two distinct components. In a similar manner, the memory storage performed by two distinct memory portions as described above may, in accordance with a further aspect of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity, i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing device what to do with the data being processed.

Further, it is appreciated that the instructions or set of instructions used in the implementation and operation of the invention may be in a suitable form such that the processing device may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing device, i.e., to a particular type of computer, for example. The computer understands the machine language.

Any suitable programming language may be used in accordance with the various aspects of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instruction or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing device, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing device, utilized to hold the set of instructions and/or the data used in the invention may take on any of a variety of physical forms or transmissions, for example. Illustratively, the medium may be in the form of a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by a processor.

Further, the memory or memories used in the processing device that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing device or machines that are used to implement the invention. As used herein, a user interface includes any hardware, software, or combination of hardware and software used by the processing device that allows a user to interact with the processing device. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing device as it processes a set of instructions and/or provides the processing device with information. Accordingly, the user interface is any device that provides communication between a user and a processing device. The information provided by the user to the processing device through the user interface may be in the form of a command, a selection of data, or some other input, for example.

As discussed above, a user interface is utilized by the processing device that performs a set of instructions such that the processing device processes data for a user. The user interface is typically used by the processing device for interacting with a user either to convey information or receive information from the user. However, it should be appreciated that in accordance with some aspects of the system and method of the invention, it is not necessary that a human user actually interact with a user interface used by the processing device of the invention. Rather, it is also contemplated that the user interface of the invention might interact, i.e., convey and receive information, with another processing device, rather than a human user. Accordingly, the other processing device might be characterized as a user. Further, it is contemplated that a user interface utilized in the system and method of the invention may interact partially with another processing device or processing devices, while also interacting partially with a human user.

It will be readily understood by those persons skilled in the art that the present invention is susceptible to broad utility and application. Many aspects and adaptations of the present invention other than those herein described, as well as many variations, modifications, and equivalent arrangements, will be apparent from or reasonably suggested by the present invention and foregoing description thereof, without departing from the substance or scope of the invention.

Accordingly, while the present invention has been described here in detail in relation to its exemplary aspects, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such aspects, adaptations, variations, modifications, or equivalent arrangements.

1. A method comprising:
receiving, at a classical computing device, a cost function, where the cost function is a function of parameters of a quantum circuit;
discretizing the cost function to determine a number of dimensions and a number of elements in each dimension;
formulating a landscape tensor, wherein the landscape tensor is formulated based on, and includes, the number of dimensions and the number of elements in each dimension;
randomly sampling values of the parameters of the quantum circuit;
executing the quantum circuit with the values of the parameters, wherein executing the quantum circuit generates values of the cost function;
inserting the values of the cost function as values of corresponding elements in the number of elements included in the landscape tensor; and
solving a low-rank tensor completion problem to estimate the values of empty elements in the number of elements included in the landscape tensor.

2. The method of claim 1, comprising:
storing the landscape tensor in a factorized form.

3. The method of claim 2, wherein the factorized form includes only low-rank decomposed factors of the landscape tensor.

4. The method of claim 1, comprising:
constructing a training data set from the values of the parameters of the quantum circuit.

5. The method of claim 4, wherein the low-rank tensor completion problem minimizes an approximation error of the training data by solving low-rank factors.

6. The method of claim 5, wherein the low-rank factors include {Aᵢ}ᵢ₌₁^{d}.

7. The method of claim 1, wherein each element of the landscape tensor is represented by a vector of matrices.

8. A system comprising at least one classical computing device including a processor and a memory, and at least one quantum computing device including a quantum processor, wherein the at least one classical computing device and the at least one quantum computing device are configured for operative communication with each other, and wherein the system is configured to:
receive, at the at least one classical computing device, a cost function, where the cost function is a function of parameters of a quantum circuit;
discretize the cost function to determine a number of dimensions and a number of elements in each dimension;
formulate a landscape tensor, wherein the landscape tensor is formulated based on, and includes, the number of dimensions and the number of elements in each dimension;
randomly sample values of the parameters of the quantum circuit;
execute the quantum circuit with the values of the parameters, wherein executing the quantum circuit generates values of the cost function;
insert the values of the cost function as values of corresponding elements in the number of elements included in the landscape tensor; and
solve a low-rank tensor completion problem to estimate the values of empty elements in the number of elements included in the landscape tensor.

9. The system of claim 8, wherein the system is configured to:
store the landscape tensor in a factorized form.

10. The system of claim 9, wherein the factorized form includes only low-rank decomposed factors of the landscape tensor.

11. The system of claim 8, wherein the system is configured to:
construct a training data set from the values of the parameters of the quantum circuit.

12. The system of claim 11, wherein the low-rank tensor completion problem minimizes an approximation error of the training data by solving low-rank factors.

13. The system of claim 12, wherein the low-rank factors include {A i}d.

14. The system of claim 8, wherein each element of the landscape tensor is represented by a vector of matrices.

15. A non-transitory computer readable storage medium, including instructions stored thereon, which instructions, when read and executed by one of a classical computer processor or a quantum computer processor, cause the classical computer processor or the quantum computer processor to perform steps comprising:
receiving, at a classical computing device, a cost function, where the cost function is a function of parameters of a quantum circuit;
discretizing the cost function to determine a number of dimensions and a number of elements in each dimension;
formulating a landscape tensor, wherein the landscape tensor is formulated based on, and includes, the number of dimensions and the number of elements in each dimension;
randomly sampling values of the parameters of the quantum circuit;
executing the quantum circuit with the values of the parameters, wherein executing the quantum circuit generates values of the cost function;
inserting the values of the cost function as values of corresponding elements in the number of elements included in the landscape tensor; and
solving a low-rank tensor completion problem to estimate the values of empty elements in the number of elements included in the landscape tensor.

16. The non-transitory computer readable storage medium of claim 15, comprising:
storing the landscape tensor in a factorized form.

17. The non-transitory computer readable storage medium of claim 16, wherein the factorized form includes only low-rank decomposed factors of the landscape tensor.

18. The non-transitory computer readable storage medium of claim 15, comprising:
constructing a training data set from the values of the parameters of the quantum circuit.

19. The non-transitory computer readable storage medium of claim 18, wherein the low-rank tensor completion problem minimizes an approximation error of the training data by solving low-rank factors including {Aᵢ}ᵢ₌₁^{d}.

20. The non-transitory computer readable storage medium of claim 15, wherein each element of the landscape tensor is represented by a vector of matrices.
